(19) United States
(12) Patent Application Publication
(10) Pub. No.: US 2021/0150134 A1
(43) Pub. Date: May 20, 2021

(54) SYSTEM AND METHOD FOR CAPTURING, CATEGORIZING, STORING,RETRIEVING AND MATCHING PERSONAL INFORMATION TO EXTERNAL DATA AND SIGNING REQUESTS

(71) Applicant: Chidi Paul Okechukwu, Beaumont Hills (AU)

(72) Inventor: Chidi Paul Okechukwu, Beaumont Hills (AU)

(21) Appl. No.: 17/159,193

(22) Filed: Jan. 27, 2021

(51) Int. Cl. G06F 40/174; G06F 16/9035; G06F 16/9038

(52) U.S. Cl. CPC G06F 40/174; G06F 16/9038; G06F 16/9035

(57) ABSTRACT

Present disclosure relates to a technique of auto-completing data entry. The technique includes receiving a request for auto-entry of personal data of a user in a Form. Further, plurality of fields of the Form are determined. The techniques further include retrieving the personal data of the user associated with the fields from a database at a server, wherein retrieving the personal data comprises matching the determined plurality of fields with fields stored in the database; and auto-filling the personal data of the user in the plurality of fields of the Form.

### TECHNICAL FIELD

Present invention relates to a system and method for capturing, categorizing, storing, retrieving and matching personal information to external data and signing requests.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generating and maintaining personal data is typically a manual process carried out by a person. Further, data entry in various forms and applications is also a manual process. This is a time-consuming manual process that is prone to errors. This makes the process of generating and maintaining personal data and utilizing the same, inefficient and time taking process.

What is needed, therefore, are techniques for automatically generating and maintaining personal data and utilizing the same. In a more general sense, there is a need for automatically generating, maintaining and utilizing the personal data with minimal or zero human intervention.

### SUMMARY

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In one non-limiting embodiment of the present disclosure, a method for autocompleting data entry is provided. The method comprises a step of receiving a request for auto-entry of personal data of a user in a Form. The method further comprises a step of determining plurality of fields of the Form. The method further comprises a step of retrieving the personal data of the user associated with the fields from a database at a server, wherein retrieving the personal data comprises matching the determined plurality of fields with fields stored in the database. Lastly, the method describes auto-filling the personal data of the user in the plurality of fields of the Form.

In another non-limiting embodiment of the present disclosure, the method describes that the personal data is stored in the database, by: analyzing one or more sources of information to extract the personal data of the user, classifying the extracted personal data of the user, and storing the classified personal data in the database.

In yet another non-limiting embodiment of the present disclosure, the method describes requesting personal information from the user for the fields for which data is not available in the database.

In yet another non-limiting embodiment of the present disclosure, the method further describes sending status updates of the form to the user and receiving response to the status update.

In yet another non-limiting embodiment of the present disclosure, a system for auto-completing data entry is provided. The system comprises at least one processor and a database storing personal data of users, coupled to the at least one processor. The at least one processing unit is configured to receive a request for auto-entry of personal data of a user in a Form, to determine plurality of fields of the Form, to retrieve the personal data of the user associated with the fields from a database at a server, wherein retrieving the personal data comprises matching the determined plurality of fields with fields stored in the database, and to auto-fill the personal data of the user in the plurality of fields of the Form.

In another non-limiting embodiment of the present disclosure, to store the personal data is stored in the database, the at least one processor is configured to analyze at least one source of information to extract personal data of the user, to classify the extracted personal data of the user, and to store the classified personal data into the database.

In yet another non-limiting embodiment of the present disclosure, wherein the personal data in the database is stored according to a pre-defined standard.

In yet another non-limiting embodiment of the present disclosure, the at least one processor further configured to request personal information from the user for the fields for which data is not available in the database.

In yet another non-limiting embodiment of the present disclosure, the at least one processor further configured to sending status update of the Form to the user and to receive response to the status update.

In yet another non-limiting embodiment of the present disclosure, A non-transitory computer readable medium for storing computer instructions for auto-completing data entry is provided. The computer instructions that, when executed by at least one processor, cause the at least one processor to perform a method for auto-completing data entry comprising: receiving a request for auto-entry of personal data of a user in a Form, determining plurality of fields of the Form, retrieving the personal data of the user associated with the fields from a database at a server, wherein retrieving the personal data comprises matching the determined plurality of fields with fields stored in the database, and auto-filling the personal data of the user in the plurality of fields of the Form.

In yet another non-limiting embodiment of the present disclosure, one user can create multiple profiles of related parties with a similar set of personal data stored for each additional profile in the database.

In yet another non-limiting embodiment of the present disclosure, the form to be auto-completed shall be converted into a custom format to match the set of predefined or selected fields in the database.

In yet another non-limiting embodiment of the present disclosure, the form fields to be auto-completed shall match the predefined custom format before the at least one processor retrieves the personal data of the user and any of the user's related parties associated with the fields from a database at a server, wherein retrieving the personal data comprises matching the determined plurality of fields with fields stored in the database.

### BRIEF DESCRIPTION OF THE ACCOMPANYING DRAWINGS

The features, nature, and advantages of the present disclosure will become more apparent from the detailed description set forth below when taken in conjunction with the drawings in which reference characters identify correspondingly throughout. Some embodiments of system and/or methods in accordance with embodiments of the present subject matter are now described, by way of example only, and with reference to the accompanying figures, in which:

FIG. 1 shows a block diagram illustrating a system for auto-completing data entry in accordance with an embodiment of the present disclosure.

FIG. 2 shows flowchart of an exemplary method for auto-completing data entry in accordance with an embodiment of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration”. Any embodiment or implementation of the present subject-matter described herein as “exemplary” is not necessarily to be construed as preferred or advantageous over other embodiments.

While the disclosure is susceptible to various modifications and alternative forms, specific embodiments thereof has been shown by way of example in the drawings and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure will be described herein below with reference to the accompanying drawings. In the following description, well known functions or constructions are not described in detail since they would obscure the description with unnecessary detail.

The present disclosure relates to a system that generates and maintains personal data of plurality of user utilizing various sources of information and thereafter autocompletes data entry in various Forms using the maintained personal data. The personal data may comprise any of following, but not limited thereto, user's name, date of birth, address, city name, details of parents and siblings, passport details, work history, medical history, mobile number, height, etc.

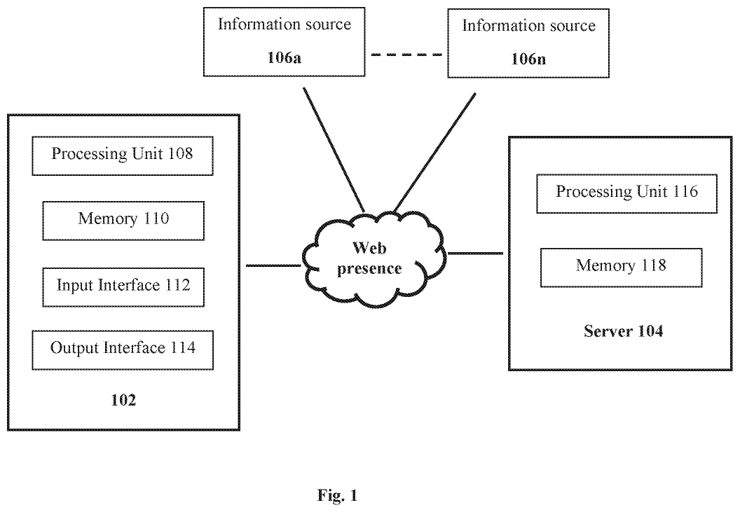

Referring to FIG. 1, an exemplary network 100 is disclosed for generating, maintaining and utilizing personal data of at least one user. The network 100 may include various elements such as a system 102, a server 104, and information sources 106a . . . 106n, which may communicate with each other over a web presence. The web presence may be any wide area network or local area network etc. but not limited thereto. The system 102, the server 104, and the information sources 106a . . . 106n may communicate with each other over wired or wireless links. The system 102 may analyze the information sources 106 to extract the personal data of the users and may store the same on the server 104. Thereafter, the system 102 may retrieve the personal data from the server for auto-completion of data entry. The information sources 106 may be any of the following, but not limited thereto, social platforms, email, user-filled data entries in one or more forms or application for various purposes, etc.

According to a non-limiting embodiment of the present disclosure, the system 102 may comprise a processing unit 108, a memory 110, an input interface 112, and an output interface 114, which may communicate with each other over wired or wireless link. The processing unit 108 may comprise at least one processor which may process the data of various types. The system 102 may analyze the information sources 106 by the processing unit 108 to extract personal data of the users. In a non-limiting exemplary embodiment of the present disclosure, in order to extract the personal data of users, the system 102 may perform following actions such as ask user direct question on call, use a chat board that is triggered by some triggers to ask specific questions to get access to the user's accounts, email and social platform analysis of the data by artificial intelligence machine learning, scanning previously filled form by the user, etc. but not limited thereto.

After extracting the personal data of the users, the processing unit 108 may classify the personal data based on various factors such as name, city, work profile, medical history, etc. But not limited thereto. Thereafter, the processing unit 108 may send the classified data to the sever 104 via the output interface 114 for storing the data into a memory of the server 104. In a non-limiting exemplary embodiment of the present disclosure, the system 102 may send the extracted personal data to the server without classifying, and a processing unit 116 of the server 104 may classify the personal data and thereafter may store the same in the memory 118. In this manner, the database of the personal data of the users may be created at the server 104.

According to a non-limiting embodiment of the present disclosure, the system 102 may receive a request for auto-entry of personal data of a user in a Form associated with the user from a third-party user. The third-party user may be an organization like a bank, school, small business, real estate agent that provides any service to the user. The system 102 may receive such requests via the input interface 112. The Form may include various fields which are required to be filled with user's personal data. In a non-limiting exemplary embodiment of the present disclosure, the Form may be any one of the following but not limited to, application to university, application to get loan, application to driving license, etc.

Upon receiving the form, the system 102 may convert the Form into a predefined standard format via the processing unit 108. The memory 110 of the system 102 may store the standard format information and rules for converting the received Form into the pre-defined standard format. Thereafter, the system 102 may process the converted Form to determine plurality of fields of the Form which require user's personal data. In a non-limiting exemplary embodiment of the present disclosure, the Form may include any identification information of the user whose personal data is required to be filled in the Form. The identification information may be any of the following, but not limited thereto, user's name, passport details, mobile number, etc. which clearly identifies the user.

After determining the Form-fields, the system 102 may retrieve personal data of the user associated with the Form-fields from the database, wherein retrieving the personal data from the database comprises matching the determined fields with fields stored in the database in the memory 118 at the server 104. After retrieving the personal data from the server 104, the system 104 may auto-fill the retrieved personal data of the user in the plurality of fields of the Form.

In a non-limiting exemplary embodiment of the present disclosure, if the system 102 does not find any match to the determined field in the database or unable to retrieve the personal data for any field of the Form, then the system 102 may request personal information form the user for the fields for which data is not available in the database. The system 102 may prompt an interface for entering the personal data. The system 102 may send the received information to the server 104 for updating the database. In this manner, the database is updated in real-time and in future may provide the updated information if required.

In a non-limiting exemplary embodiment of the present disclosure, the system 102 may also provide status communication of the Form. The system 102 may allow third party to send status updates via API to the user. The status updates may include, but are not limited to, approved, rejected, need more information, pending, phased approval, etc. that trigger next stage forms, information requests or processes. The system 102 may also receive user response to status updates via the API. The system 102 may also trigger logical next stage Forms for completion and auto-completion.

In this manner, the system 102 generates and maintains the personal data of the users and auto-complete the data entry into various Forms using the maintained personal data without human intervention and with very little human intervention. The system also reduces the time taken in all these processes and improves the accuracy of data. Hence, the overall process becomes more efficient and accurate and chances of errors are eliminated or reduced.

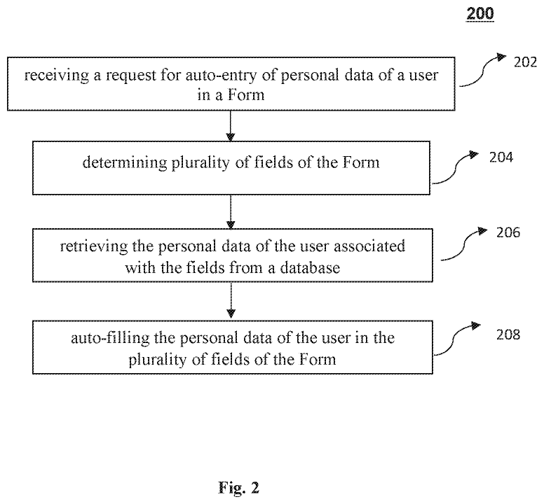

FIG. 2 shows a flowchart of an exemplary method 200 for auto-completing data entry in accordance with a non-limiting embodiment of the present disclosure. At block 202, the method describes receiving a request for auto-entry of personal data of a user in a Form. The request may be received by the system 102 via an input interface from a third-party user. The third-party user may be an organization like a bank, school, small business, real estate agent that provides any service to the user. The personal data may comprise any of following, but not limited thereto, user's name, date of birth, address, city name, details of parents and siblings, passport details, work history, medical history, mobile number, height, etc. In a non-limiting exemplary embodiment of the present disclosure, the Form may be any one of the following but not limited to, application to university, application to get loan, application to driving license, etc.

At block 204, the method describes determining plurality of fields of the Form. The system 102 may convert the received Form into a pre-defined standard format and then may process the converted Form to determine the fields which require the personal data of the user. At block 206, the method describes retrieving the personal data of the user associated with the fields from a database at a server, wherein retrieving the personal data comprises matching the determined plurality of fields with fields stored in the database. At step 208, the method describes auto-filling the personal data of the user in the plurality of Form-fields of the Form.

According to a non-limiting exemplary embodiment of the present disclosure, in order to create the database of the personal data, the system 102 may analyze the information sources 106 by the processing unit 108 to extract personal data of the users. In another non-limiting exemplary embodiment of the present disclosure, in order to extract the personal data of users, the system 102 may perform following actions such as ask user direct question on call, use a chat board that is triggered by some triggers to ask specific questions to get access to the user's accounts, email and social platform analysis of the data by artificial intelligence machine learning, scanning previously filled form by the user, etc. but not limited thereto.

In the same embodiment, after extracting the personal data of the users, the processing unit 108 may classify the personal based on various factors such as name, city, work profile, medical history, etc. But not limited thereto. Thereafter, the processing unit 108 may send the classified data to the server 104 via the output interface 114 for storing the data into a memory of the server 104. In a non-limiting exemplary embodiment of the present disclosure, the system 102 may send the extracted data to the server without classifying the data, and a processing unit of the server 104 may classify the personal data and thereafter may store the same in the memory. In this manner, the database of the personal data of the users may be created at the server 104.

In a non-limiting embodiment of the present disclosure, the method 200 may also provide status communication of the Form. The method comprises sending status updates via API to the user by the third party. The status updates may include, but are not limited to, approved, rejected, need more information, pending, phased approval, etc. that trigger next stage forms, information requests or processes. The method also includes receiving user responses to status updates via the API. The system 102 may also trigger logical next stage Forms for completion and auto-completion.

In this manner, the personal data of the users may be generated and maintained and data entry into various Forms is autocompleted using the maintained personal data without human intervention and with very little human intervention. This also reduces the time taken in all these processes and improves the accuracy of data. Hence, the overall process becomes more efficient and accurate and chances of errors are eliminated or reduced.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed.

Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

What is claimed is:

1. A method for auto-completing data entry, the method comprising:
receiving a request for auto-entry of personal data of a user in a Form;
determining plurality of fields of the Form;
retrieving the personal data of the user associated with the fields from a database at a server, wherein retrieving the personal data comprises matching the determined plurality of fields with fields stored in the database; and
auto-filling the personal data of the user in the plurality of fields of the Form.

2. The method as claimed in claim 1, wherein the personal data is stored in the database, by:
analyzing one or more sources of information to extract the personal data of the user;
classifying the extracted personal data of the user; and
storing the classified personal data in the database.

3. The method as claimed in claim 2, wherein the personal data in the database is stored according to a predefined standard.

4. The method as claimed in claim 1, wherein the method further comprises requesting personal information from the user for the fields for which data is not available in the database.

5. The method as claimed in claim 1, wherein the method further comprises sending status update of the form to the user and receiving response to the status update.

6. A system for auto-completing data entry, the system comprises:
at least one processor; and
a database storing personal data of users, being coupled to the at least one processor, wherein the at least one processor is configured to:
receive a request for auto-entry of personal data of a user in a Form,
determine plurality of fields of the Form,
retrieve the personal data of the user associated with the fields from a database at a server, wherein retrieving the personal data comprises matching the determined plurality of fields with fields stored in the database, and
auto-fill the personal data of the user in the plurality of fields of the Form.

7. The system as claimed in claim 6, wherein, to store the personal data in the database, the at least one processor is configured to:
analyze at least one source of information to extract personal data of the user;
classify the extracted personal data of the user; and
store the classified personal data into the database.

8. The system as claimed in claim 7, wherein the personal data in the database is stored according to a predefined standard.

9. The system as claimed in claim 6, wherein at least one processor further configured to request personal information from the user for the fields for which data is not available in the database.

10. The system as claimed in claim 6, wherein at least one processor further configured to send status updates of the Form to the user and to receive response to the status update.

11. A non-transitory computer readable medium for storing computer instructions that, when executed by at least one processor, cause the at least one processor to perform a method for auto-completing data entry comprising:
receiving a request for auto-entry of personal data of a user in a Form;
determining plurality of fields of the Form;
retrieving the personal data of the user associated with the fields from a database at a server, wherein retrieving the personal data comprises matching the determined plurality of fields with fields stored in the database; and
auto-filling the personal data of the user in the plurality of fields of the Form.

12. The computer readable medium as claimed in claim 11, wherein the personal data is stored in the database, by:
analyzing at least one source of information to extract personal data of the user;
classifying the extracted personal data of the user; and
storing the classified personal data into the database.

13. The computer readable medium as claimed in claim 12, wherein personal data in the database is stored according to a predefined standard.

14. The computer readable medium as claimed in claim 11, wherein the computer instructions when executed, further cause the at least one processor to request personal information from the user for the fields for which data is not available in the database.

15. The computer readable medium as claimed in claim 11, wherein the computer instructions when executed, further cause the at least one processor to send a status update of the Form to the user and receive response to the status update.
